(19) United States
(12) Patent Application Publication
(10) Pub. No.: US 2014/0108631 A1
(43) Pub. Date: Apr. 17, 2014

(54) SERVICE LOCATION PROTOCOL BASED DYNAMIC ANALYTICS NETWORK METHOD AND APPARATUS

(71) Applicant: Stephen Whitney, Monkstown (IE)

(72) Inventor: Stephen Whitney, Monkstown (IE)

(21) Appl. No.: 13/651,314

(22) Filed: Oct. 12, 2012

(51) Int. Cl. H04L 29/08

(52) U.S. Cl. CPC H04L 67/16
USPC 709/223

(57) ABSTRACT

A system, method, and computer-readable storage medium configured to enable the transportation of interaction point data in a dynamic analytics network. A transport node registers a Service Location Protocol service message with a distribution daemon via a network interface. The message includes a data point identifier. When the transport node receives a data point from the distribution daemon, it uses its processor to determine whether the data point correlates with an identifier entry. The transport node forwards the data point to a storage node identified within the identifier entry when the data point correlates with an identifier entry.

### BACKGROUND

1. Field of the Invention

Aspects of the disclosure relate to computer networking. Aspects include an apparatus, system, method and computer-readable storage medium of a service location protocol based dynamic analytics network.

2. Description of the Related Art

A dynamic analytics network is a network that analyzes how users interact with a computer system to give key insights into how to perform the task the user is trying to accomplish. To gather this data, each interaction/data point of interest is instrumented and each point is logged.

To analyze this data, it needs to be transported and stored. If a computer system anticipates and instruments too little interaction/data points, the analytics that can be performed on a small data set are limited and the ability to perform analysis related to interaction/data points that were not stored is impossible. To widen the data set, the computer system must re-instrument additional interaction/data points, inflicting a cost in the development, the testing and the upgrading of the system.

Conversely, if a computer system anticipates and instruments many interaction/data points, the large data sets can become unwieldy to transport, store and analyze. Instrumentation, in abundance, can also consume a large amount of resources required by the computer system (CPU cycles and RAM for computation, network bandwidth for transport, RAM and storage space for persistence) and this can have a negative effect on the performance of the computer system.

### SUMMARY

Embodiments include a system, device, method and computer-readable medium to enable the transportation of interaction point data in a dynamic analytics network. A transport node registers a Service Location Protocol service message with a distribution daemon via a network interface. The message includes a data point identifier. When the transport node receives a data point from the distribution daemon, it uses its processor to determine whether the data point correlates with an identifier entry. The transport node forwards the data point to a storage node identified within the identifier entry when the data point correlates with an identifier entry.

### BRIEF DESCRIPTION OF THE DRAWINGS

FIG. 1 illustrates an embodiment of a dynamic analytics network system configured to dynamically collect data points using a service location protocol.

FIG. 2 depicts an embodiment of a node in a dynamic analytics network configured to dynamically collect data points using a service location protocol.

FIG. 3 depicts a method embodiment of a system node discovering transport nodes on a dynamic analytics network using a service location protocol.

FIG. 4 flowcharts method in which transport nodes use a service location protocol to discover storage nodes on the dynamic analytics network.

FIG. 5 depicts data/interaction points flowing through a dynamic analytics system embodiment.

FIG. 6 flowcharts a method embodiment in which a transport node is initialized and distribution daemons are self-configured to perform data/interaction point routing in a dynamic analytics network system.

FIG. 7 an method embodiment in which storage nodes are initialized and transport nodes are self-configured for data/interaction point routing in a dynamic analytics network system.

FIG. 8 an method embodiment in which a distribution daemon is initialized and a transport node is self-configured for transport nodes on the network for data/interaction point routing in a dynamic analytics network system.

FIG. 9 depicts initialization of a transport node and self-configuration of a storage node on the dynamic analytics network for data/interaction point routing using a service location protocol.

### DETAILED DESCRIPTION

One aspect of the disclosure includes that a service location protocol may be adapted to create a scalable dynamic analytics network. Embodiments remove the transport and storage overhead of large amounts of instrumentation data.

In another aspect of the disclosure, each node in the dynamic analytics network is free to instrument as many interaction/data points as required, without concern for the transport and storage of the masses of data produced. Each interaction/data point is given an identifier.

In another aspect of the disclosure, the performance impact on the system nodes due to high amounts of instrumentation is handled and reduced by a self-configuring distribution daemon. A system node passes all instrumented data to the distribution daemon, that can be running on or logically connected to the system node. The distribution daemon can distribute interaction/data points to multiple transport nodes, where each transport node is performing different analytics on the received data.

In some embodiments, self-configuring transport nodes may be dynamically introduced during periods of high instrumentation to ensure critical interaction/data points are processed quickly. Transport nodes publish their existence using a Service Location Protocol, and transport the identifiers of the interaction/data points. Service Location Protocol may also be used to route interaction/data points to storage nodes.

At any time a transport node can be introduced to the network begin capturing interaction/data points as distribution daemons will react to their Service Location Protocol publication and re-configure themselves to distribute the required interaction/data points to the transport node.

In certain embodiments, live data may be analyzed at the transport node level without storing any amount of data where non-computationally intensive analytics over multiple or single interaction/data points is required.

Additionally, self-configuring storage nodes may be introduced dynamically during periods of high instrumentation to ensure critical interaction/data points are persisted quickly.

A storage node may be introduced to the network to begin storing interaction/data points instantly as transport nodes will react to their Service Location Protocol publication and re-configure themselves to distribute the required interaction/data points to the storage node.

Embodiments increase the ease in which ad-hoc data is collected. Using a transport node, live data can be analyzed instantly simply by initializing the transport node and advertising the desire for the required interaction/data points. Similarly, should the data processed by any transport node be required for offline, long-term or computationally-intensive analytics the data can be captured instantly simply by initializing a storage node and advertising the desire for the required interaction/data points.

These and other benefits may be apparent in hindsight to one of ordinary skill in the art.

Embodiments of the present disclosure include a system, method, and computer-readable storage medium configured to use a service location protocol in a dynamic analytics network.

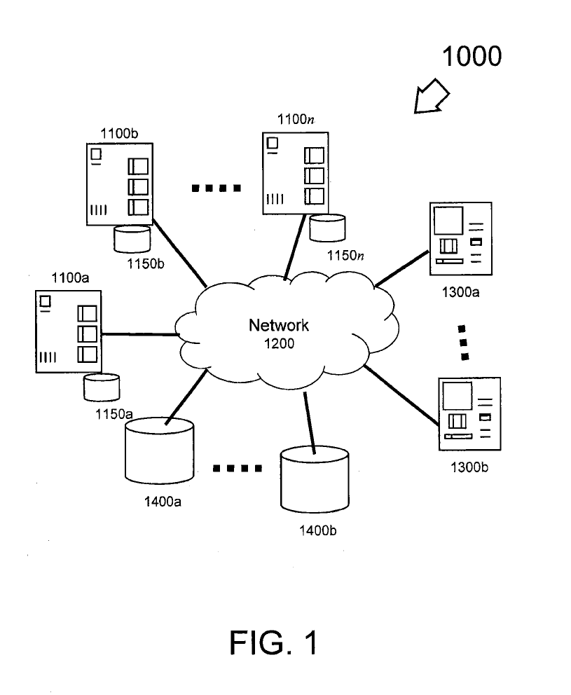

FIG. 1 illustrates an embodiment of a system 1000 configured to use a service location protocol in a dynamic analytics network, constructed and operative in accordance with an embodiment of the present disclosure. System 1000 includes system nodes 1100a-n that pass all instrumented data to a distribution daemon 1150a-n, which may be running on or logically connected to the system node 1100a-n. It is understood by those familiar with the art that the distribution daemon 1150 may be located proximate to the system node, or configuration could be stored centrally, accessed over the network and updated by all nodes. Distribution daemon 1150a-n communicates with transport nodes 2000a-b via a data network 1200. Depending upon how the instrumented data is flagged, transport nodes 2000 may route the instrumented data for analysis and/or storage. Storage may occur at a storage node 1400a-b. It is understood by those practiced in the art that a system 1000 includes at least one storage node 1100 and one transport node 2000; system 1000 may further include storage nodes 1400 for storing the instrumented data. In some embodiments, a system node 1100 or transport node 2000 may also serve as another type of node.

Data network 1200 may be any digital data communications network known in the art for interfacing, communicating or transferring data between nodes; examples of such networks include Transmission Control Protocol/Internet Protocol (TCP/IP), Ethernet, Fiber Distributed Data Interface (FDDI), token bus, or token ring networks.

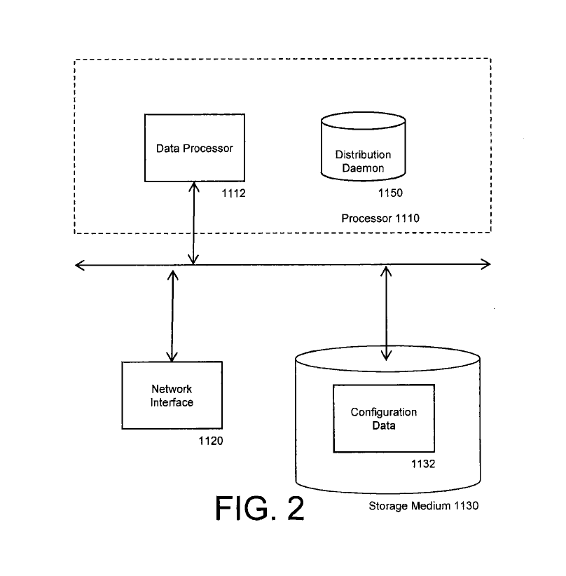

Embodiments will now be disclosed with reference to a block diagram of an exemplary system node of FIG. 2, constructed and operative in accordance with an embodiment of the present disclosure. It is understood by those in the art that each node may be a system node 1100, transport node 1300, and/or storage node 1400, depending upon the function it is performing.

The node may run a multi-tasking operating system (OS) and include at least one processor or central processing unit (CPU) 1110, a non-transitory computer-readable storage medium 1130, and a network interface 1120.

Processor 1110 may be any central processing unit, microprocessor, micro-controller, computational device or circuit known in the art. As shown in FIG. 2, processor 1110 is functionally comprises a data processor 1112, which interfaces with storage media 1130 and network interface 1120. The data processor 1112 enables processor 1110 to locate data on, read data from, and write data to, these components. In nodes functioning as a system node 1100, a distribution daemon 1150 may be running on or logically connected to the system node 1100. For illustrative purposes only, this embodiment depicts the distribution daemon 1150 running on the system node 1100.

Network interface 1120 may be any data port as is known in the art for interfacing, communicating or transferring data across a computer network, examples of such networks include Transmission Control Protocol/Internet Protocol, Ethernet, Fiber Distributed Data Interface, token bus, or token ring networks. Network interface 1120 allows a node to communicate with other nodes over the data network 1200.

Computer-readable storage media 1130 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage media 1130 may be remotely located from processor 1110, and be connected to processor 1110 via a network such as a local area network (LAN), a wide area network (WAN), or the Internet 1200.

Additionally, computer-readable storage media 1130 is able to store configuration data 1132 for the node. Configuration 1132 may be in any data format known in the art, including a linked-list, flat file, database, or other data format.

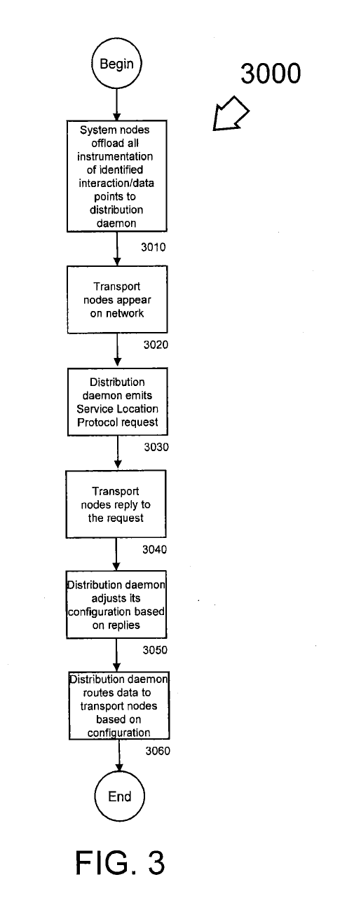

The function of these structures may best be understood with respect to the flowcharts of FIGS. 3-9, as described below.

We now turn our attention to method or process embodiments of the present disclosure, FIGS. 3-9. It is understood by those known in the art that instructions for such method embodiments may be stored on their respective computer-readable memory and executed by their respective processors. It is understood by those skilled in the art that other equivalent implementations can exist without departing from the spirit or claims of the invention.

FIG. 3 depicts a method embodiment 3000 of a system node 1100 discovering transport nodes on a dynamic analytics network 1000, constructed and operative in accordance with an embodiment of the present disclosure.

For the collection of data, each node in the system 1000 is free to instrument as many interaction/data points as required. Each interaction/data point is given a unique identifier. The system node 1100 passes all instrumented data to a distribution daemon 1150, that can be running proximate to the system node 1100, block 3010. System node 1100 may produce at least two identified types of instrumentation: “browse” and/or “register.”

The distribution daemon 1150 is configured to distribute certain interaction/data points based on their identifiers and to discard those that are not needed. In one embodiment, the distribution daemon 1150 will be preset to discard all interaction/data points.

One or many transport nodes 2000 are introduced to the network 1000 at block 3020, and these transport nodes 2000 publish their existence using Service Location Protocol along with the identifiers of the interaction/data points the transport node 2000 is responsible for transporting.

At block 3030, the distribution daemon 1150 uses a Service Location Protocol request to discover transport nodes on the network. In some embodiments, the distribution daemon 1150 may use Service Location Protocol at periodic intervals; in yet another embodiment, the intervals may be random or otherwise optimized for the network 1000. As a distribution daemon can process many different types of identified interaction/data point instrumentation, so can a transport node.

Each transport node 2000 replies to the Service Location Protocol request block 3040, advertising their service and the types of instrumentation the transport node 2000 is interested in receiving. When a distribution daemon 1150 identifies a new transport node 2000 from the reply, the distribution daemon 1150 automatically adjusts its configuration 1132 based on the identifiers published by the transport node, block 3050. Distribution daemon 1150 then begins routing relevant instrumented interaction/data points to the transport node 2000, block 3060.

In one embodiment, the distribution daemon 1150 adjust its configuration 1132 based on the Service Location Protocol replies and begins routing “browse” and “register” instrumentation to the transport nodes 2000 interested in receiving this data.

Transport nodes 2000 may be configured to perform live analytics on the interaction/data points it receives and then discard the information.

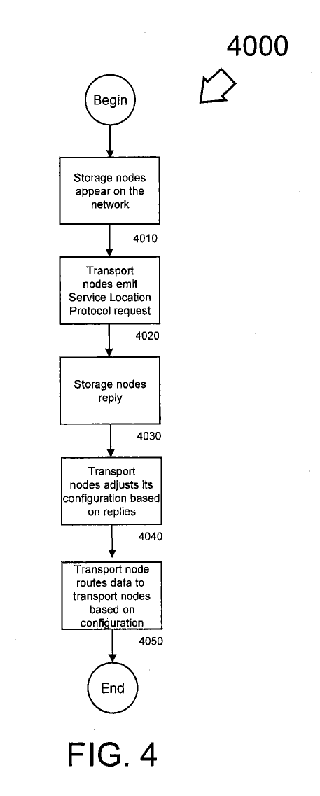

Moving to FIG. 4, a flowcharts depicts a method 4000 in which transport nodes 2000 use Service Location Protocol to discover storage nodes 1400 on the dynamic analytics network 1000, constructed and operative in accordance with an embodiment of the present disclosure.

Storage nodes 2000 are introduced to the network, at block 4010. Similarly to transport nodes, storage nodes 2000 will publish their existence using Service Location Protocol along with the identifiers of the interaction/data points the storage node is responsible for storing.

Similar to distribution daemon 1150 or transport node 2000, storage node 1400 can process many different types of identified interaction/data point instrumentation. In one embodiment, the storage nodes 2000 are interested in “browse” and/or “register” instrumentation data.

After an interval, transport nodes 2000 use a Service Location Protocol request to discover storage nodes 1400 on the network 1000 at block 4020.

In turn, each storage node 1400 replies, advertising their service and the types of instrumentation data they are interested in receiving, block 4030.

When a transport node 2000 receives the reply from the storage node 1400, the transport node 2000 identifies the storage node 1400 on the network 1000. The transport node 2000 automatically adjusts its configuration 1132 based on the identifiers published by the storage node 1400, block 4040. The transport node 2000 then begins routing relevant instrumented interaction/data points to the storage node 1400.

Storage nodes 1400 are configured to store the interaction data points that they receive. The data may then be used for analysis at a later date.

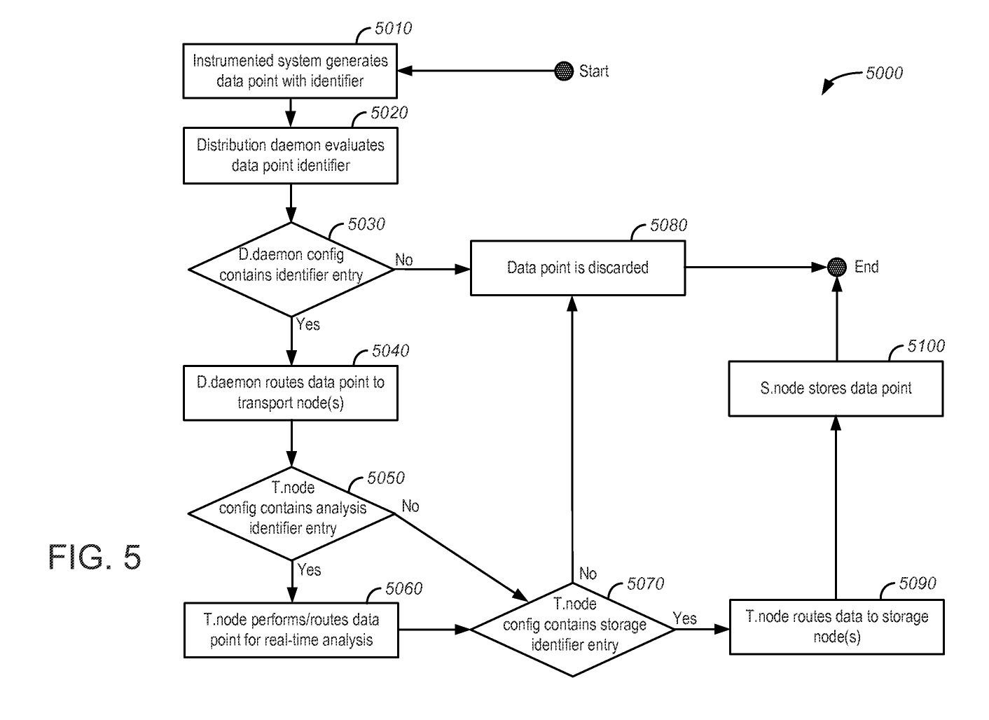

FIG. 5 depicts method 5000, wherein data/interaction points flow through a dynamic analytics system embodiment, constructed and operative in accordance with an embodiment of the present disclosure.

A system node 1100 generates an instrumented data point with an identifier, block 5010. Distribution daemon 1150 evaluates the data point identifier at block 5020.

At decision block 5030, distribution daemon 1150 determines whether its configuration 1132 contains an identifier entry that matches the instrumented data point. If there is no match, the data point is discarded at block 5080, and the process ends. However, if there is a match, process 5000 continues at block 5040.

The distribution daemon 1150 routes the data point to a transport node 2000 at block 5040.

At decision block 5050, transport node 2000 determines whether its configuration 1132 contains an identifier entry that matches the instrumented data point. If there is no match, the process continues at block 5070. However, if there is a match, the transport node 2000 may either perform an analysis using the data point, or route the data point to another node for analysis, block 5060; the process 5000 continues at block 5070.

At decision block 5070, transport node 2000 determines whether its configuration 1132 contains a storage identifier entry that matches the instrumented data point. If there is no match, the data point is discarded at block 5080, and the process ends. However, if there is a match, the transport node 2000 routes the data point, or route the data point to a storage node 1400 for storage, block 5090.

The storage node 1400 stores the data point for future analysis at block 5100, and the process ends.

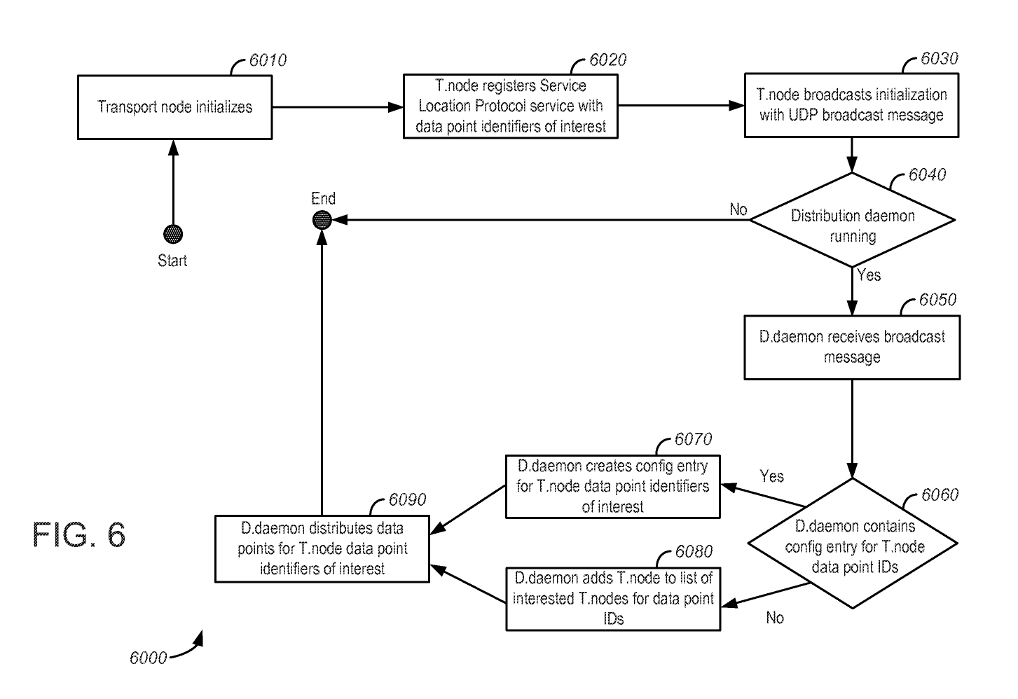

FIG. 6 flowcharts a method embodiment 6000 in which a transport node is initialized and distribution daemons are self-configured to perform data/interaction point routing in a dynamic analytics network system, constructed and operative in accordance with an embodiment of the present disclosure.

A transport node 2000 initializes at block 6010. The transport node 2000 registers Service Location Protocol service with data point identifiers of interest, block 6020. Transport node 2000 broadcasts the initialization at block 6030. The broadcast may be any network broadcast known in the art, including, but not limited to: a User Datagram Protocol (UDP) broadcast message or a TCP/IP broadcast message.

If no distribution daemon 1150 is running, as determined by decision block 6040, the process ends.

If a distribution daemon 1150 is running, as determined by decision block 6040, the daemon 1150 receives the broadcast message, block 6050.

At decision block 6060, distribution daemon 1150 searches its configuration 1132 to determine whether it contains a configuration entry for a transport node data entry point identifier. If there is, the daemon 1150 creates a configuration entry for the transport node 2000 data point identifiers of interest, block 6070. If not, the daemon 1150 adds the transport node 2000 to a list of transport nodes for the data point identifiers, block 6080.

Distribution daemon 1150 distributes the data points to the transport node, block 6090, and process 6000 ends.

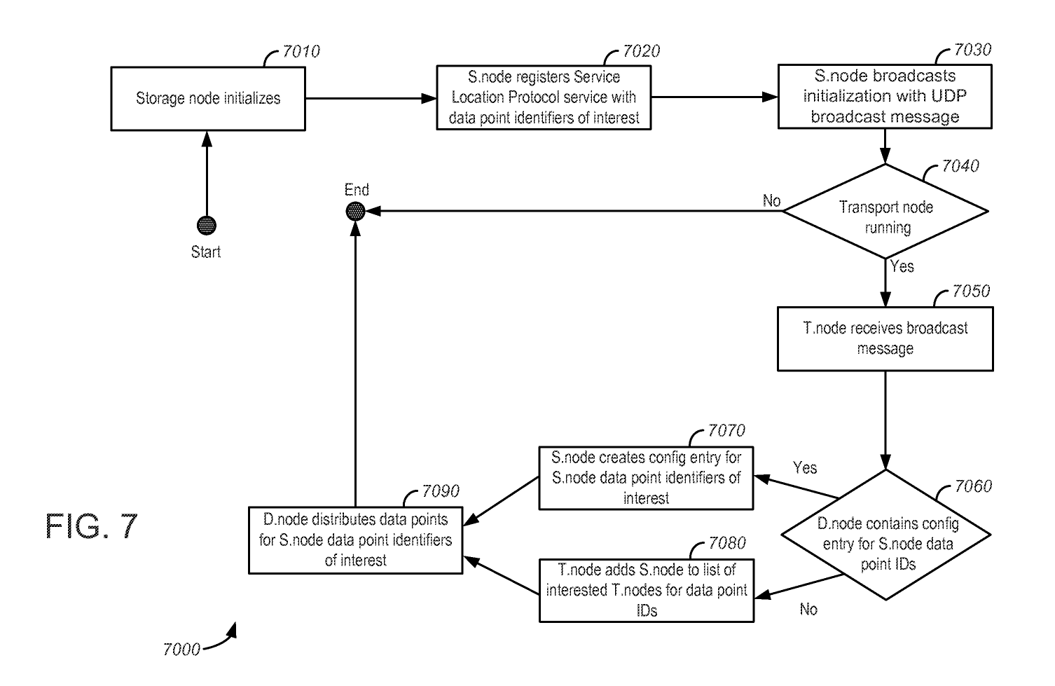

FIG. 7 an method embodiment 7000 in which storage nodes are initialized and transport nodes are self-configured for data/interaction point routing in a dynamic analytics network system, constructed and operative in accordance with an embodiment of the present disclosure.

A storage node 1400 initializes at block 7010. The storage node 1400 registers Service Location Protocol service with data point identifiers of interest, block 7020. Storage node 1400 broadcasts the initialization at block 7030. The broadcast may be any network broadcast known in the art, including, but not limited to: a User Datagram Protocol (UDP) broadcast message or a TCP/IP broadcast message.

If no transport node 2000 is running, as determined by decision block 7040, the process ends.

If a transport node 2000 is running, as determined by decision block 7040, the transport node 2000 receives the broadcast message, block 7050.

At decision block 7060, transport node 2000 searches its configuration 1132 to determine whether it contains a configuration entry for a storage node data entry point identifier. If there is, the transport node 2000 creates a configuration entry for the storage node 1400 data point identifiers of interest, block 7070. If not, the transport node 2000 adds the storage 1400 to a list of storage nodes for the data point identifiers, block 7080.

Transport node 2000 distributes the data points to the storage node 1400, block 7090, and process 7000 ends.

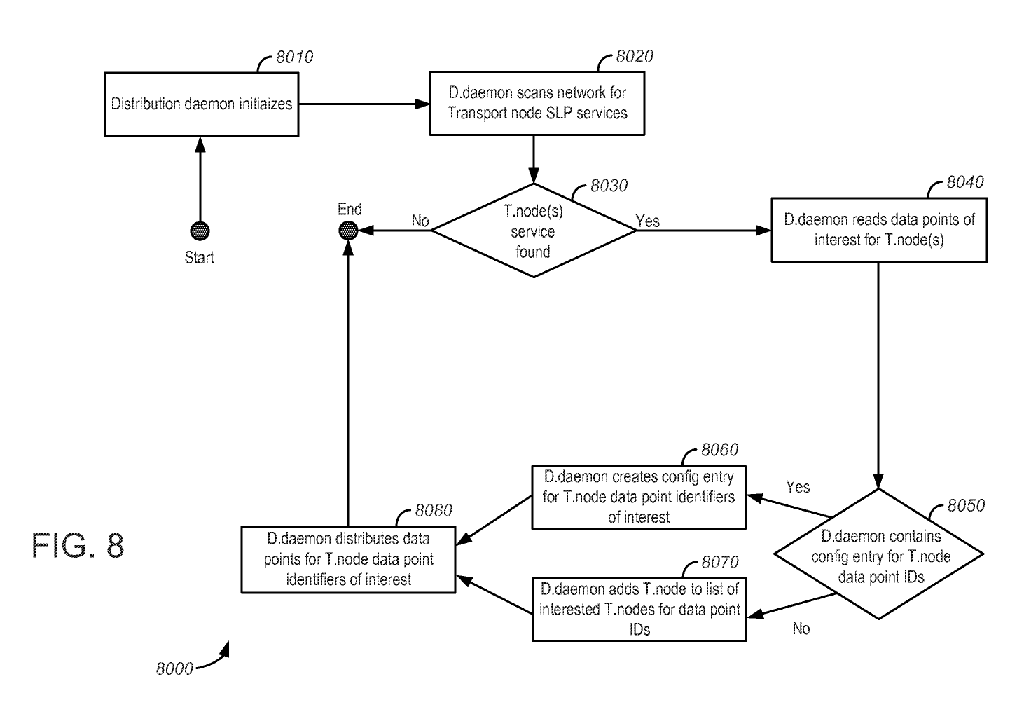

FIG. 8 a method embodiment 8000 in which a distribution daemon is initialized and a transport node is self-configured for transport nodes on the network for data/interaction point routing in a dynamic analytics network system, constructed and operative in accordance with an embodiment of the present disclosure.

A distribution daemon 1150 initializes at block 8010. The distribution daemon 1150 scans the data analysis network 1000 for transport node Service Location Protocol services, block 8020.

If no transport node 2000 is running, as determined by decision block 8030, the process ends.

If a transport node 2000 is running, as determined by decision block 8030, the distribution daemon 1150 reads that data points of interest from transport node 2000, block 8040.

At decision block 8050, distribution daemon 1150 searches its configuration 1132 to determine whether it contains a configuration entry for a transport node data entry point identifier. If there is, the distribution daemon 1150 creates a configuration entry for the transport node 2000 data point identifiers of interest, block 8060. If not, the distribution daemon 1150 adds the transport node to a list of transport nodes for the data point identifiers, block 8070.

Distribution daemon 1150 distributes the data points to the transport node 2000, block 8080, and process 8000 ends.

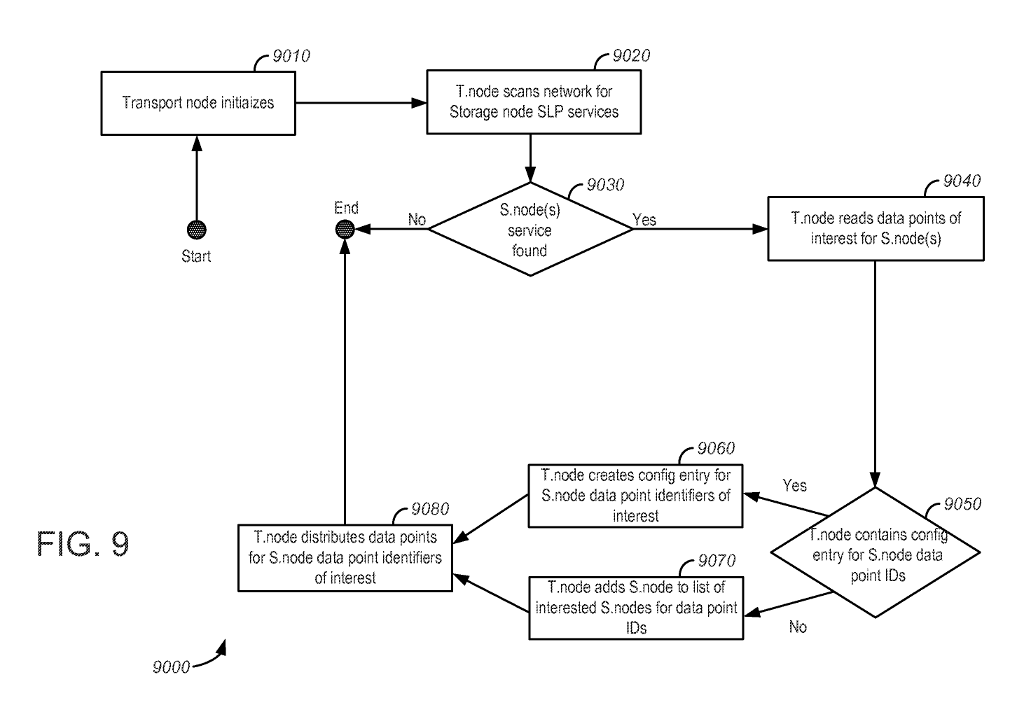

FIG. 9 depicts initialization method 9000 of a transport node and self-configuration of a storage node on the dynamic analytics network for data/interaction point routing, constructed and operative in accordance with an embodiment of the present disclosure.

A transport node 2000 initializes at block 9010. The transport node 2000 scans the data analysis network 1000 for storage node Service Location Protocol services, block 9020.

If no storage node 1400 is found, as determined by decision block 9030, the process ends.

If a storage node 1400 is found, as determined by decision block 9030, the transport node 2000 reads that data points of interest from storage node 1400, block 9040.

At decision block 9050, transport node 2000 searches its configuration 1132 to determine whether it contains a configuration entry for a storage node data entry point identifier. If there is, the transport node 2000 creates a configuration entry for the storage node 1400 data point identifiers of interest, block 9060. If not, the transport node 2000 adds the storage node to a list of storage nodes for the data point identifiers, block 9070.

Transport node 2000 distributes the data points to the storage node 1400, block 9080, and process 9000 ends.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A method of transporting interaction point data in an analytics network, comprising:
registering a Service Location Protocol service message with a distribution daemon via a network interface, the message including a data point identifier;
receiving a data point from the distribution daemon via the network interface;
determining with a processor whether the data point correlates with an identifier entry;
forwarding, via network interface, the data point to a storage node identified within the identifier entry when the data point correlates with an identifier entry.

2. The method of claim 1, further comprising:
analyzing the data point with the processor.

3. A apparatus for transporting interaction point data in an analytics network, comprising:
a network interface configured to registering a Service Location Protocol service message with a distribution daemon, the message including a data point identifier, the network interface further configured to receive a data point from the distribution daemon;
a processor configured to determine whether the data point correlates with an identifier entry;
wherein the network interface is further configured to forward the data point to a storage node identified within the identifier entry when the data point correlates with an identifier entry.

4. The apparatus of claim 3, wherein the processor is further configured to analyze the data point.

5. A non-transitory computer readable medium encoded with data and instructions such that when read by a computing device causes the computing device to:
register a Service Location Protocol service message with a distribution daemon via a network interface, the message including a data point identifier;
receive a data point from the distribution daemon via the network interface;
determine with a processor whether the data point correlates with an identifier entry;
forward, via network interface, the data point to a storage node identified within the identifier entry when the data point correlates with an identifier entry.

6. The computer readable medium of claim 5, further causing the computing device to:
analyze the data point with the processor.

7. A method of transporting interaction point data in an analytics network, comprising:
receiving a Service Location Protocol service message from a transport node via a network interface, the message including a data point identifier;
determining with a processor whether a stored configuration entry exists for the data point identifier;
creating a configuration entry for the data point identifier when no stored configuration entry exists;
associating the transport node with the stored configuration entry when the stored configuration entry exists.

8. The method of claim 7, further comprising:
distributing data points to the transport node when the data point matches the stored configuration entry.

9. An apparatus for transporting interaction point data in an analytics network, comprising:
a network interface configured to receive a Service Location Protocol service message from a transport node, the message including a data point identifier;
a processor configured to determine whether a stored configuration entry exists for the data point identifier, to create a configuration entry for the data point identifier when no stored configuration entry exists, and associate the transport node with the stored configuration entry when the stored configuration entry exists.

10. The apparatus of claim 9, wherein the network interface is further configured to distribute data points to the transport node when the data point matches the stored configuration entry.

11. A non-transitory computer readable medium encoded with data and instructions such that when read by a computing device causes the computing device to:
receive a Service Location Protocol service message from a transport node via a network interface, the message including a data point identifier;
determine with a processor whether a stored configuration entry exists for the data point identifier;
create a configuration entry for the data point identifier when no stored configuration entry exists;
associate the transport node with the stored configuration entry when the stored configuration entry exists.

12. The computer readable medium of claim 11, further causing the computing device to:
distribute data points to the transport node when the data point matches the stored configuration entry.

13. A method of transporting interaction point data in an analytics network, comprising:
registering a Service Location Protocol service message with a transport node via a network interface, the message including a data point identifier;
receiving a data point from the transport node via the network interface;
storing the data point on a non-transitory computer-readable storage medium.

14. An apparatus for transporting interaction point data in an analytics network, comprising:
a network interface configured to register a Service Location Protocol service message, the message including a data point identifier, and to receive a data point from the transport node via the network interface;
a non-transitory computer-readable storage medium configured to store the data point.

15. A non-transitory computer readable medium encoded with data and instructions such that when read by a computing device causes the computing device to:
register a Service Location Protocol service message with a transport node via a network interface, the message including a data point identifier;
receive a data point from the transport node via the network interface;
store the data point on the non-transitory computer-readable storage medium.
